(19) United States
(12) Patent Application Publication
(10) Pub. No.: US 2024/0079814 A1
(43) Pub. Date: Mar. 7, 2024

(54) CONNECTOR FOR A SINGLE TWISTED PAIR OF CONDUCTORS

(71) Applicant: CommScope Technologies LLC, Hickory, NC (US)

(72) Inventors: Paul John PEPE, Clemmons, NC (US); Shawn Philip TOBEY, Trinity, NC (US)

(73) Assignee: CommScope Technologies LLC, Hickory, NC (US)

(21) Appl. No.: 18/262,453

(22) PCT Filed: Jan. 20, 2022
(86) PCT No.: PCT/US2022/013137

§ 371 Date: Jul. 21, 2023

Related U.S. Application Data
(60) Provisional application No. 63/139,891, filed on Jan. 21, 2021.

(51) Int. Cl. H01R 13/502; H01R 4/2425; H01R 13/6463; H01R 43/18

(52) U.S. Cl. CPC H01R 13/502; H01R 4/2425; H01R 13/6463; H01R 43/18

(57) ABSTRACT

A connector includes a forward connector body, a rear connector body that interfaces with the forward connector body and a metal frame positioned about the forward and rear connectors bodies. The rear connector body defines a central channel to receive a single pair of conductors. Each of a first and second side face of the rear connector body includes an elongate opening that extends through a front face of the rear connector body to provide access to an upward channel and a downward channel, respectively, of a contact receiving portion of the rear connector body. The metal frame includes a rearward portion and a forward portion. The rearward portion of the metal frame is positioned about the rear connector body as well as a rearward portion of the forward connector body while the forward portion of the metal frame is positioned about a forward portion of the forward connector body.

### CROSS-REFERENCE TO RELATED APPLICATION

This application is being filed on Jan. 20, 2022 as a PCT International Patent Application and claims benefit of U.S. Patent Application Ser. No. 63/139,891, filed on Jan. 21, 2021, the disclosure of which is incorporated herein by reference in its entirety.

### TECHNICAL FIELD

The present disclosure is directed to connectors and, more specifically, to connectors for use with a single-twisted pair of conductors.

### BACKGROUND

A single twisted pair of conductors can be used to transmit data and/or power over a communications network that includes, for example, computers, servers, cameras, televisions, and other electronic devices including those on the internet of things (VT), etc. In the past, this has been performed through use of Ethernet cables and connectors that typically include four pairs of conductors that are used to transmit four differential signals. Differential signaling techniques, where each signal is transmitted over a balanced pair of conductors, are used because differential signals may be affected less by external noise sources and internal noises sources such as crosstalk as compared to signals that are transmitted over unbalanced conductors.

In Ethernet cables, the insulated conductors of each differential pair are tightly twisted about each other to form four twisted pairs of conductors, and these four twisted pairs may be further twisted about each other in a so-called “core twist.” A separator may be provided that is used to separate and hence reduce coupling between) at least one of the twisted pairs from at least one other of the twisted pairs. The four twisted pairs and any separator may be enclosed in a protective jacket. Ethernet cables are connectorized with Ethernet connectors; a single Ethernet connector is configured to accommodate all four twisted pairs of conductors. However, it is possible that data and power transfer can be effectively supported through a singled twisted pair of conductors with its own more compact connector and cable. Couplers that can enable electrical coupling of connectors, with each connector coupled to a single pair of electrical conductors, are an important element in broadening the use of data and power transfer over a single pair of electrical conductors.

### SUMMARY

A connector includes a forward connector body, a rear connector body that interfaces with the forward connector body and a metal frame positioned about the forward and rear connectors bodies. The rear connector body defines a central channel to receive a single pair of conductors. Each of a first and second side face of the rear connector body includes an elongate opening that extends through a front face of the rear connector body to provide access to an upward channel and a downward channel, respectively, of a contact receiving portion of the rear connector body. The metal frame includes a rearward portion and a forward portion. The rearward portion of the metal frame is positioned about the rear connector body as well as a rearward portion of the forward connector body while the forward portion of the metal frame is positioned about a forward portion of the forward connector body. The connector provides transmission of both power and data.

In certain embodiments, the front face of the rear connector body presents a flat surface while the edges of the front face are beveled. In certain embodiments, the metal frame is a unitary component having beveled forward-facing edges. In certain embodiments, the metal frame includes first and second cantilevered side arms where each of the first and second cantilevered side arms includes a cut-out that interfaces with a projections located on the forward portion of the forward connector body. In certain embodiments, the first cantilevered side arm is positioned about an upper face, a first side and a lower face of the forward portion of the forward connector body while the second cantilevered side arm includes a recessed portion that is conformed to a keying notch in a second side of the forward portion of the forward connector body; the second cantilevered side arm is positioned about a second side and the lower face of the forward portion of the forward connector body. In certain embodiments, the forward connector body includes a cantilevered latch that is supported by a t-mount. In certain embodiments, the connector further includes exactly two contacts with each having first ends that comprise a tuning fork contact and having second ends that comprise insulation displacement contacts (IDCs). In certain embodiments, the single pair of conductors, comprising a first conductor and a second conductor, are electrically coupled to first and second contacts of the exactly two contacts with the electrically coupled conductors and contacts transmitting both power and data.

A method of assembling a connector that includes a metal frame having a forward portion and a rearward portion, a rearward connector body, and a forward connector body interfacing with the rearward connector body includes: (a) positioning the rearward portion of the metal frame about both the rearward connector body and a portion of the forward connector body; (b) flexing the first cantilevered arm to place the first cantilevered arm in contact with the forward connector body including contact with an upper face, a first side face and a lower face of the forward connector body and securing the first cantilevered arm in position; and (c) flexing the second cantilevered to place the second cantilevered arm in contact with the forward connector body including with contact with a second side face and the lower face of the forward connector body and securing the second cantilevered arm in position.

In certain embodiments, positioning the rearward portion of the metal frame additionally includes positioning a portion of the metal frame beneath a cantilevered latch of the connector and immediately proximate a t-shaped mount of the cantilevered latch. In certain embodiments, the second cantilevered arm is additionally placed in contact with a keying notch of the forward connector body and is conformed to a shape of the keying notch. In certain embodiments, the contact of the first cantilevered arm with the upper face of the forward connector body extends from the first side face of the forward connector body to the second side face of the forward connector body. In certain embodiments, the method additionally includes beveling at least a position of forward facing edges of the metal frame. In certain embodiments, the method further comprises housing exactly two power- and data-transmitting contacts within the forward connector body.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE FIGURES

FIGS. 1A-1B illustrate example embodiments of cables having single twisted pairs of conductors.

FIGS. 2A-2D illustrate an example embodiment of a free connector for a single pair of electrical conductors including an assembled view, an exploded assembly view, a cross section of a forward connector body of the connector and a pair of electrical contacts of the connector, respectively.

FIGS. 3A-3C illustrate an example embodiment of a fixed connector, which is configured to mate with the free connector of FIGS. 2A-2D, including an assembled perspective view, a front view and a pair of electrical contacts of the fixed connector, respectively.

FIGS. 4A-4D illustrate an example embodiment of a shielded coupler including an assembled perspective, an exploded assembly perspective, a side cross-sectional, and a top cross-sectional view of the coupler, respectively.

FIGS. 5A-5B provide perspective views of a pair of the connectors of FIGS. 2A-2D before and after electrical coupling with the coupler of FIGS. 4A-4D.

FIG. 6 is an exploded perspective view of a free connector.

FIGS. 7A-7B comprise a first side perspective of the free connector of FIG. 6 and a first side perspective of the free connector of FIG. 6 with a metal frame separated from a coupled forward connector body and rear connector body, respectively.

FIGS. 8A-8B comprise a second side perspective of the free connector of FIG. 6 and a second side perspective of the free connector of FIG. 6 with a metal frame separated from a coupled forward connector body and rear connector body, respectively.

FIGS. 9A-9B comprise a lower face perspective of the free connector of FIG. 6 and the lower face perspective with a metal frame removed from the free connector, respectively.

FIG. 10 comprises an upper perspective view of a metal frame of the free connector of FIG. 6.

FIGS. 11A-11B comprise upper and lower perspective views of the rear connector body of the free connector of FIG. 6.

FIGS. 12A-12B comprises left and right perspective views of the rear connector body of the free connector of FIG. 6.

### DETAILED DESCRIPTION

A connector of the present disclosure includes a forward connector body, a rear connector body that interfaces with the forward connector body and a metal frame positioned about the forward and rear connectors bodies. The rear connector body defines a central channel to receive a single pair of conductors. Each of a first and second side face of the rear connector body includes an elongate opening that extends through a front face of the rear connector body to provide access to an upward channel and a downward channel, respectively, of a contact receiving portion of the rear connector body. The metal frame includes a rearward portion and a for and portion. The rearward portion of the metal frame is positioned about the rear connector body as well as a rearward portion of the forward connector body while the forward portion of the metal frame is positioned about a forward portion of the forward connector body. The connector is particularly suited to the combined transmission of both power and data.

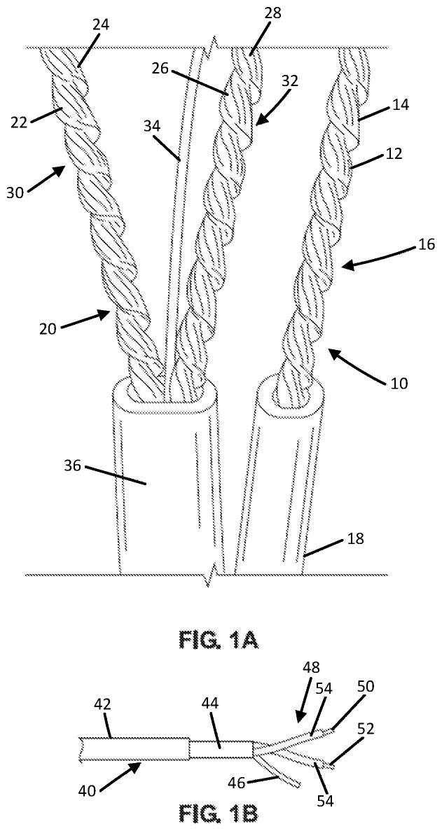

FIG. 1A illustrates two example embodiments of cables containing one or more single twisted pairs of conductors capable of transmitting electricity, data or both electricity and data. The first cable 10 includes first and second conductors 12, 14 that are twisted together to form a single twisted pair 16. The conductors 12, 14 are enclosed by a protective jacket 18. The second cable 20 includes first through fourth conductors 22, 24, 26, 28. Conductors 22 and 24 are twisted together to form a first single twisted pair 30, and conductors 26 and 28 are twisted together to form a second single twisted pair 32. The twisted pairs 30 and 32 are separated by a separator 34 and are encased in a protective jacket 36. In certain example embodiments, the cables 10, 20 include a number of twisted pairs greater than two. In certain example embodiments, each single twisted pair of conductors, e.g., 16, 30, 32, is configured for both power and data transmission, e.g. data transmission up to 600 MHz (ifs) and a current carrying capacity up to 1A. Each single twisted pair of conductors, e.g., 16, 30, 32, can be connectorized with the various embodiments or combination of embodiments of free connectors and fixed connectors as described herein. FIG. is an example of a shielded cable 40. The shielded cable 40 includes an outer jacket 42, a foil shield 44, a drain wire 46, and a single twisted pair 48 of conductors 50 and 52; each of the conductors 50 and 52 is provided with insulation 54.

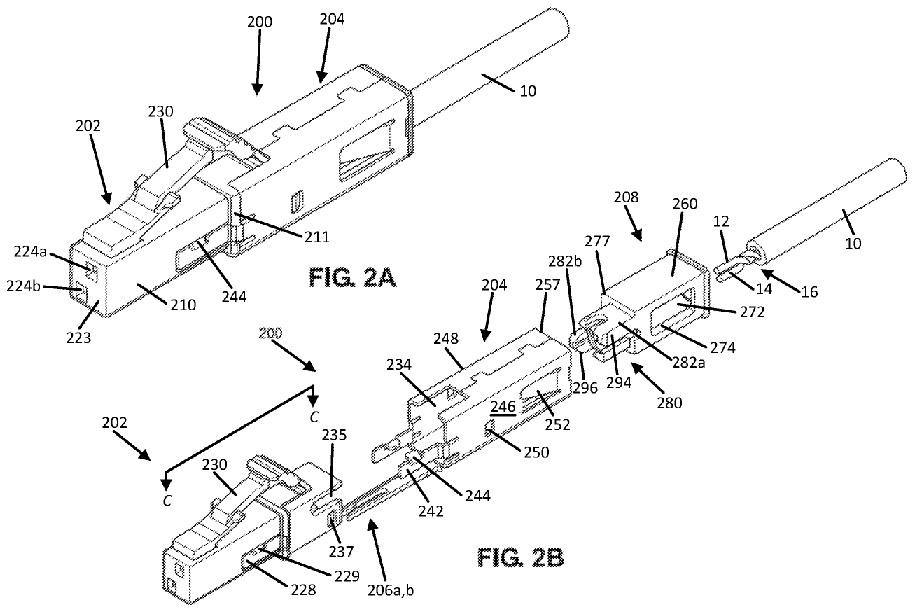

Referring to FIGS. 2A-2D an example embodiment of a free connector 200 for a single twisted pair of electrical conductors is illustrated. Free connector 200 includes a forward connector body 202, a metal frame 204, a pair of electrical contacts 206a, 206b and a rear connector body 208. Free connector 200 can be coupled to a single twisted pair of conductors, e.g., conductors 12 and 14 of the single twisted pair 16 of cable 10.

The forward connector body 202 includes an elongate forward portion 210 and a rear receiving portion 212 that is separated by a shoulder 211.

The elongate forward portion 210 of the forward connector body 202 includes a forward face 223 having a pair of offset openings 224a, 224b corresponding to contact receiving channels 226a, 226b; the openings 224a, 224b receive pin contacts that electrically interface with the tuning fork contacts 206a, 206b. In certain embodiments, a recess 228 is provided on each side face of the elongate forward portion 210 to interface with and retain the metal frame 204. Each recess 228 includes a recessed notch 229 to receive an interfacing tab 244 of the metal frame 204 to further ensure that the metal frame 204 remains secured to the forward connector body 202. The forward connector body 202 also includes a cantilevered latch 230.

The rear receiving portion 212 of the forward connector body 202 is unitary (e.g. molded as a single unit) with the elongate forward portion 210 of the forward connector body 202, The rear receiving portion 212 defines a central cavity 232 that provides rear access to the contact receiving channels 226a, 226b of the elongate forward portion 210, Each side face 231, 233 of the rear receiving portion 212 includes a slot 235 to interface with the rear connector body 208 and an outward extending tab 237 to interface with the metal frame 204.

The metal frame 204 of the free connector 200 comprises a metal shell body 240 having a central cavity 234 that is slidable over the rear receiving portion 212 of the forward connector body 202. The metal frame 204 is held in place about the rear receiving portion 212 through use of a pair of flex tabs 242 that interface with corresponding recesses 228 of the forward connector body 202, Each of the flex tabs 242 includes in inward facing tab 244 to interface with recessed notch 229 of the forward connector body 202. Each side face 246, 248 of the metal frame 204 includes an opening 250 to interface with outward extending tab 237 of the forward connector body 202. Each point of interface between the metal frame 204 and the forward connector body 202 assists in securing the metal frame 204 to the forward connector body 202. Each side face 246, 248 of the metal frame 204 is additionally equipped with an inward directed beam 252 (e.g. shield beam) to establish an electrical interface with a cable shield (foil or drain wire) of the cable carrying the single pair of conductors (e.g., see FIG. 1B). Note that, while the metal frame 204 includes a shield beam for interfacing with a shield of a shielded cable, the metal frame 204 can also be utilized in conjunction with a non-shielded cable. In the instance of a non-shielded cable, the metal frame provides additional structural support to the connector 200. In certain non-shielded uses, the frame 204 is alternatively made of a non-metal material, e.g., plastic.

Electrical contacts 206a. 206b each include a forward portion having a tuning fork receptacle contact 254a, 254b while a rear portion of each of the electrical contacts 206a, 206b includes an insulation displacement contact (IDC) 255a, 255E), Each tuning fork receptacle contact 254a, 254b includes a pair of opposing spring arms 60a, 60b presenting an angled opening to receive a pin contact. Each of the electrical contacts 206a, 206b includes a shoulder 256a, 256b that interfaces with a stop 258 (see FIG. 2C) within the elongate forward portion 210 of the forward connector body 202. The electrical contacts 206a, 206b include one or more tangs 259 to help retain each of the tuning fork receptacle contacts 254a, 254b within their respective contact receiving channels 226a, 226b of the forward connector body 202.

The rear connector body 208 of the free connector 200 includes a rear body portion 260 that defines a central cavity 272 into which is inserted a pair of conductors (e.g., conductors 12, 14). Each side face is provided with an elongate opening 274 into which the inward directed beams 252 of the metal frame 204 extend wherein an electrical interface with the foil (or drain wire) of a conductor within the cavity 272 is established. A latch (now shown) on a lower face of the rear body portion 260 interfaces with a cut-out (not shown) of the metal frame 204 to secure the rear connector body 208 to the metal frame 204. A lip edge 277 of the rear body portion 260 seats against a rear face 257 of the metal frame 204.

The rear connector body 208 of the free connector 200 includes a contact receiving portion 280 that extends forward from the rear body portion 260. The contact receiving portion 280 is essentially divided into a first half 282a to accommodate the upper positioned electrical contact 206a and a second half 282b to accommodate the lower positioned electrical contact 206b. The first half 282a of the contact receiving portion 280 includes an upward channel that is contoured to direct the end of a conductor upward (e.g., a 90 deg. bend) to extend through a contact receiving slot. The second half 282b of the contact receiving portion 280 includes a downward channel that is contoured to direct the end of a conductor downward (e.g., a 90 deg. bend) to extend through a contact receiving slot.

The IDC contacts 255a, 255a of the electrical contact 206a, 206b are inserted into their respective contact receiving slots to establish an electrical interface with the conductor extending there through. The IDC contacts 255a, 255b applies a normal force to the respective conductor and cuts through both the insulation of the conductor and a portion of the conductor itself to create the electrical interface. Note that the electrical interface is established without requiring crimping of the conductor to the electrical contact, i.e., the electrical interface is crimp-less. The upward channel is, in part, defined by an upper outward extending arm 294 while the downward channel is, in part, defined by a lower outward extending arm 296. Each of upper outward extending arm 294 and lower outward extending arm 296 interface with respective corresponding slots 235 of the forward connector body 202 when the free connector 200 is assembled to assist in aligning and stabilizing the rear connector body 208 relative to the forward connector body 202.

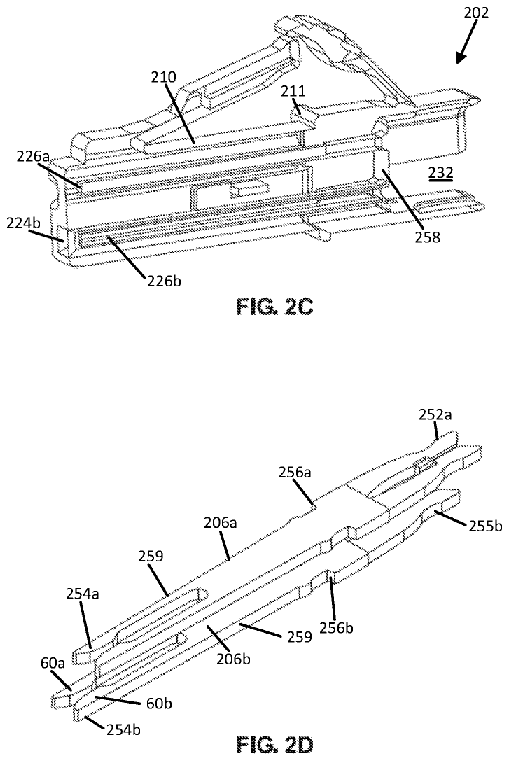

An example of a fixed connector 300, suitable to mate with free connector 200 is illustrated in FIGS. 3A-3C. The fixed connector 300 generally includes a housing body 302, a metal frame 304 and a pair of pin contacts 306a, 306b (straight or bent for board mounting). A forward end 303 and a rearward end 305 further define the fixed connector 300.

The housing body 302 of the fixed connector 300 includes a forward central channel 310 that receives the free connector 200. A notch 323 is provided within the housing body 302 to interface with the cantilevered latch 230 of the free connector 200. Further, side recesses 325 in each side face serve as an interface element for the metal frame 304. A mounting pin 327 extends from the housing body 302 and through the metal frame 2602 for circuit board mounting of the connector 300. The housing body further includes openings 326a, 326b to channels (not shown) into which the pin contacts 306a, 306b are inserted; when fully inserted, the pin contacts 306a, 306b extend into the forward central channel 310.

The metal frame 304 of the fixed connector 300 is a metal shell defining a central cavity that is slidable over the housing body 302. The metal frame 304 is held in place about the housing body 302 through use of a pair of clips 336 that interface with the side recesses 325. In certain embodiments, a back face 338 of the metal frame is enclosed with a back panel 340 while in other embodiments t back face 338 is left open. Further, in certain embodiments, the metal frame 304 is provide with one or more shield pins 342 that are insertable into vias in an application where the fixed connector 300 is board mounted.

Each of the pin contacts 306a, 306b of the fixed connector 300 include a forward portion 350 and a rear portion 352 that can be electrically coupled to a conductor, e.g., conductor 10, in any suitable manner. The forward portion 350 includes tapered faces that form a four-sided pyramid shape with a flattened apex 357; the flattened apex 357 having a rectangular or square cross-section.

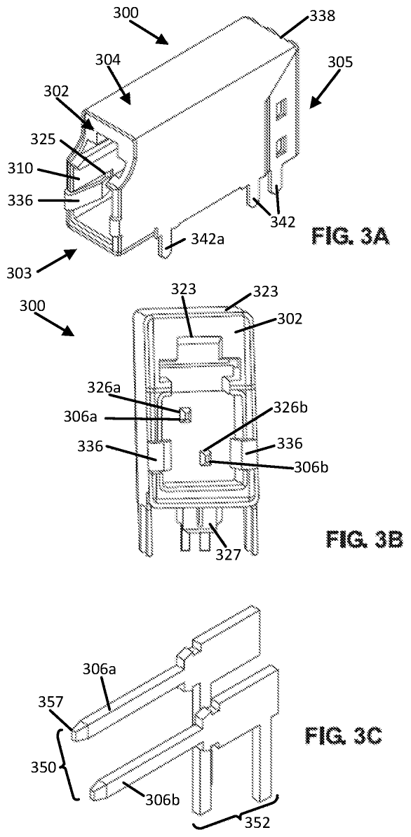

Referring to FIGS. 4A-4B an example embodiment of a coupler 400 is illustrated. As shown, the coupler 400 includes a first housing 402, a second housing 404, a metal shield 406 and a pair of contacts 408, each having a forward contact 408a and a rearward contact 408b separated by a central portion 408c. The first housing and second housing 402, 404 securely interface with one other to centrally support the first pair of contacts 408 enabling the first ends 408a of the contacts 408 to extend towards a first end 412 of the coupler 400 and the second ends 408b of the coupler 400 to extend towards a second end 414 of the coupler. FIGS. 4C and 4D provide cross-sectional views of the assembled coupler, including the metal shield 406, taken along lines 4C-4C and 4D-4D, respectively, of FIG. 4A, with each illustrating the placement of the first housing 402, the second housing 404, the metal shield 406 and the pair of contacts 408.

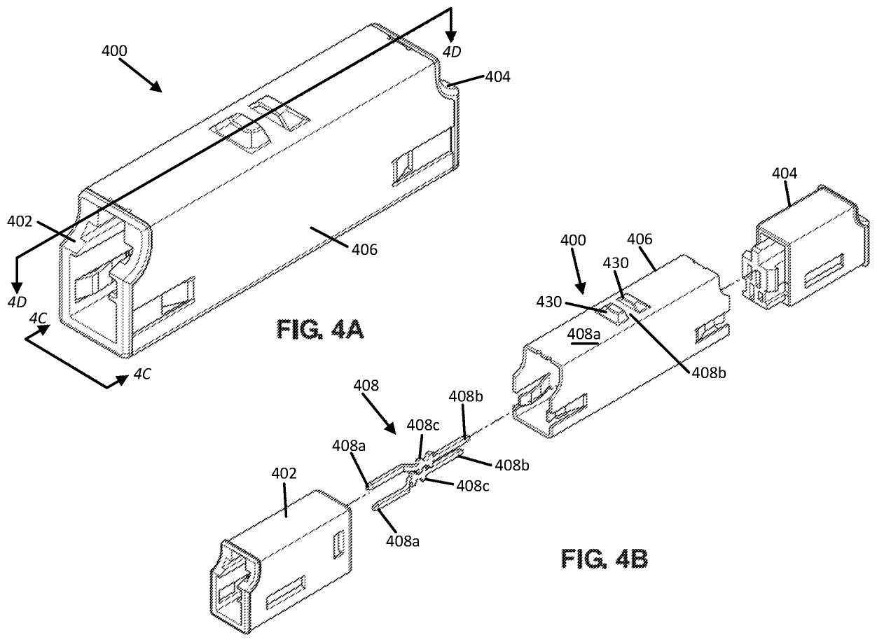

FIGS. 5A and 5B illustrate the assembled coupler 400 with two of the free connectors 200 ready to be received by the coupler 400 and with the two connectors 200 removably received within the coupler 400 and electrically coupled, respectively. Each of the couplers 400 includes a pair of opposing projections 430 projecting away from a top face 432 of the coupler 400; the projections 430 define a channel 434. The projections 430 and channel 434 are used to position the coupler 400 in the high density panel 600 further described herein. Other coupler designs for coupling a pair of connectors, with each of the connectors coupled to exactly two electrical conductors, are also possible.

Further details regarding free connectors, fixed connectors and couplers can be found in PCT publications WO 2018/200528, WO 2019/165466, and WO 2020/190758 as well as PCT Application No. PCT/US2020/053283. The identified PCT publications and applications are hereby incorporated by reference.

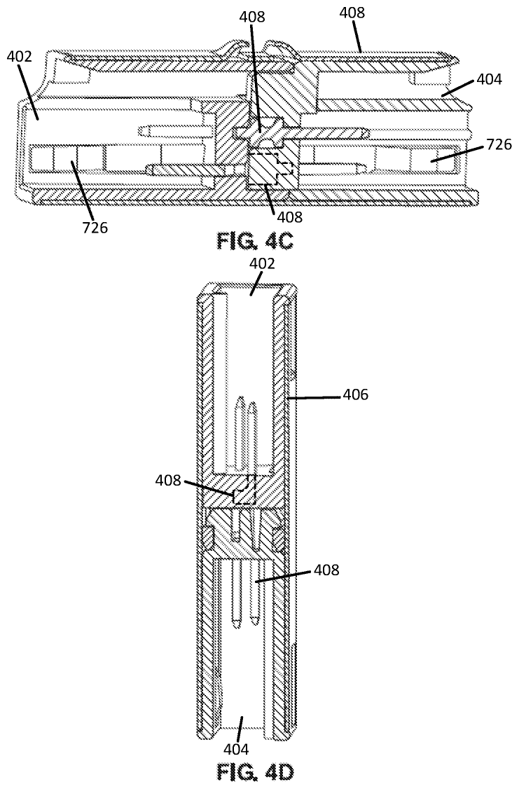

FIG. 6 illustrates another example embodiment of a free connector 600. The free connector 600 includes a forward connector body 602, a metal frame 604, the pair of electrical contacts 206a, 206b, which are also shown in use with free connector 200, and a rear connector body 608.

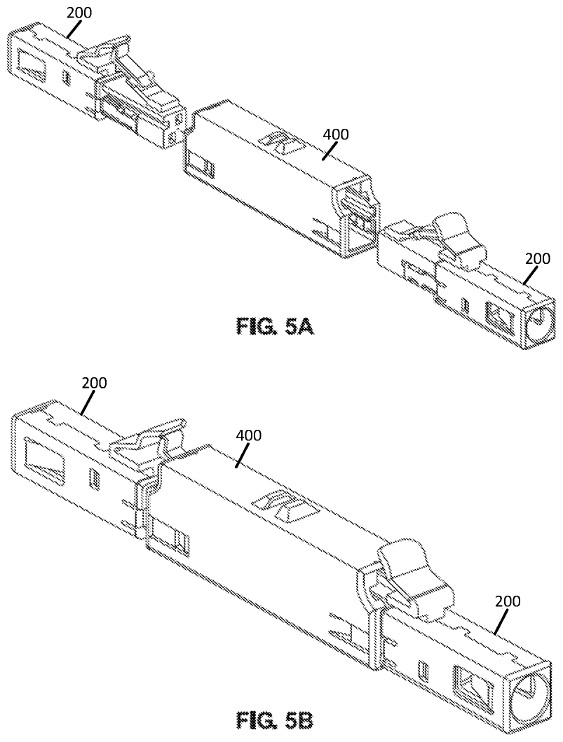

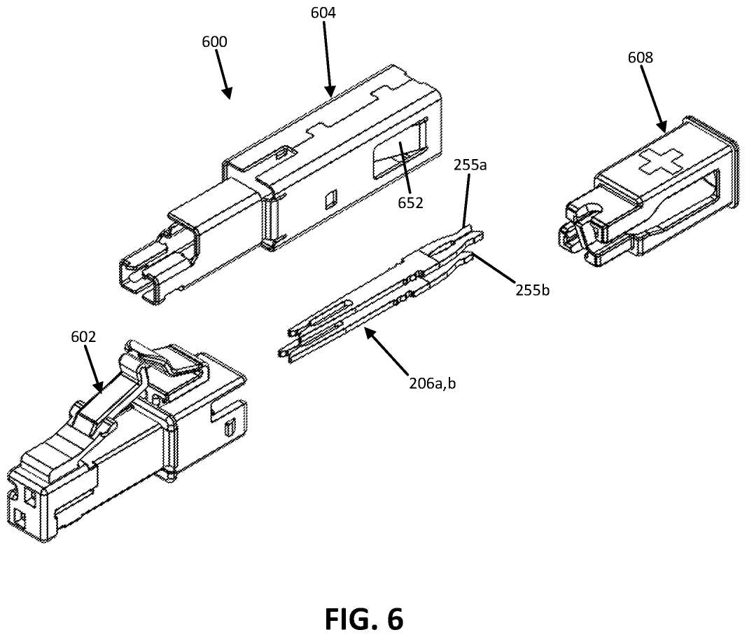

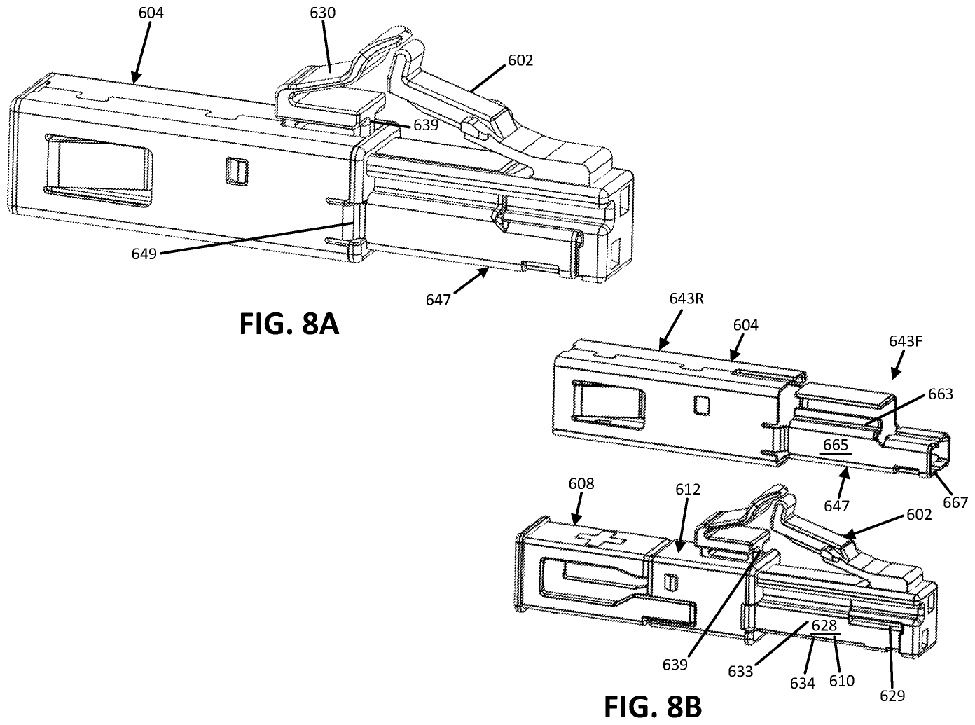

The forward connector body 602 generally corresponds to the forward connector body 202 of the free connector 200 while the metal frame generally corresponds to the metal frame 204 of the free connector 200, However, modifications made to the forward connector body 202, now evident in forward connector body 602, and modifications made to the metal frame 204, now evident in metal frame 604 can be appreciated with respect to FIGS. 7A-7B, 8A-8B, 9A-98 and 10.

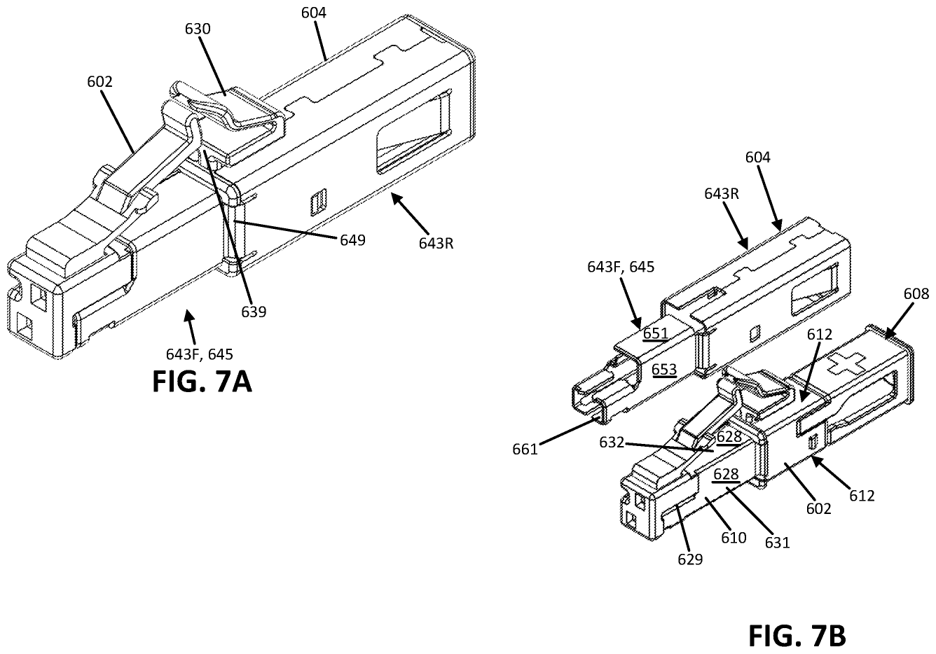

As shown, the forward connector body 602 of connector 600 includes an elongate forward portion 610 having a first side 631 and a second side 633 connected by an upper face 632 and a lower face 634 where each of the sides 631, 633 and faces 632, 634 includes a recessed portion 628 to accommodate a more expansive metal frame 604 that now covers a greater portion of each of the sides 631, 633 as well as now covering a portion of both the upper and lower faces 632, 634; the more expansive metal frame 604 provides improved coupling attenuation over metal frame 204. Further, the elongate forward portion 610 of the forward connector body 602 is provided with a recessed notch 629 on each of the first and second sides 631, 633 enabling an interface with the metal frame 604. A rear portion of the cantilevered latch 630, located on the rear receiving portion 612 of the forward connector body 602, is provided with a narrow t-shaped mount 639 enabling the expanded metal frame 604 to lie proximate the t-shaped mount 639 as well as lie beneath the rear portion of the cantilevered latch 630. Referring to FIGS. 9A-9B, the elongate forward portion 610 further includes projections 641a, 641b extending from respective first and second sides 631, 633 to lower face 634 that further serve to interface with the metal frame 604 and assist in retaining the metal frame 604 in place relative to the forward connector body 602.

The metal frame 604, similar to metal frame 204, includes a rear portion 643R positioned about the rear body portion 608 of the connector 600 and about the rear receiving portion 612 of the forward connector body 602 of the connector 600. The metal frame 604 additionally includes a forward portion 643F′ that is unitary with the rear portion 643R. The forward portion 643F, positioned about the elongate forward portion 610 of the forward connector body 602, includes a cantilevered first side arm 645 and a cantilevered second side arm 647 each of which is coupled to the rear portion 643R of the metal frame 604 by a flexible hinge 649 allowing the first and second side portions 645, 647 to flex inward/outward as needed during assembly of the free connector 600. In certain embodiments the forward portion 643F of the metal frame 604 comprises a component distinct from the rear portion 643R, e.g., the metal frame 604 comprises two or more discrete pieces.

The first side arm 645 of the metal frame 604 includes an upper face 651 that transitions to a first side 653 and to a first lower face 661. The second side arm 647 of the metal frame 605 includes a recessed side 663, conformed to a keying notch 664, that transitions to a second side 665 and a second lower face 667. Each of the first side arm 645 and the second side arm 647 includes a cut-out 669a, 669b to interface with projections 641a, 641b of the forward connector body 602, Each of the first side arm 645 and the second side arm 647 of the metal frame 604 additionally includes an interfacing tab 644 to interface with a corresponding recessed notch 629 of the forward connector body 602. The interfacing tabs 644 include edge tangs 669 to assist in retaining the interfacing tabs 644 within the respective recessed notches 629, Most, or all, of the forward facing edges of the metal frame 605, such as edges 670, 671, 672, are beveled as an anti-snag feature to enable smooth insertion of the free connector 600 into a fixed connector.

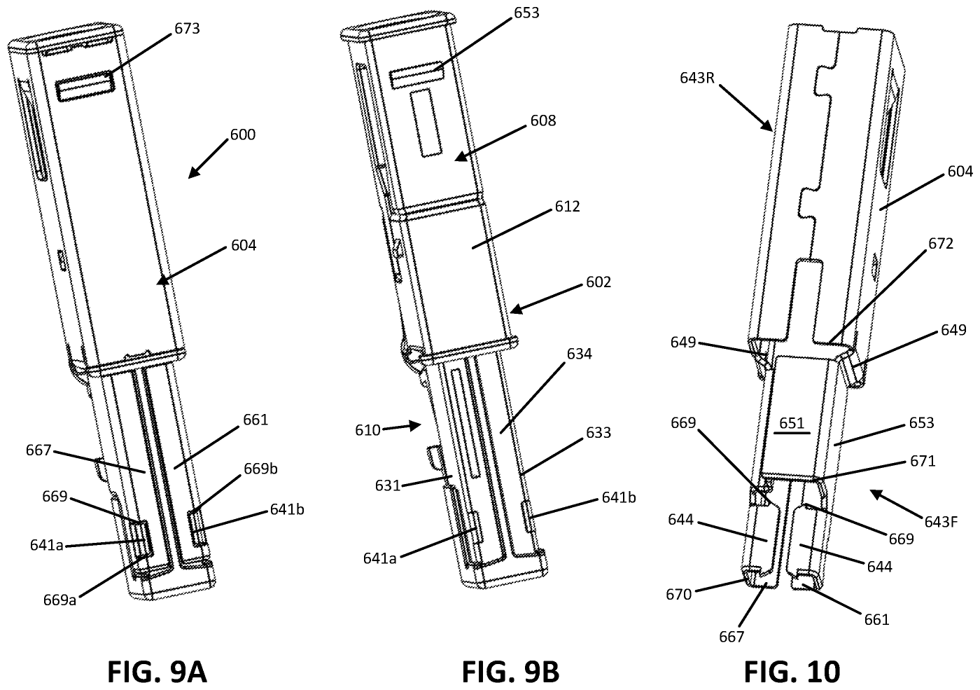

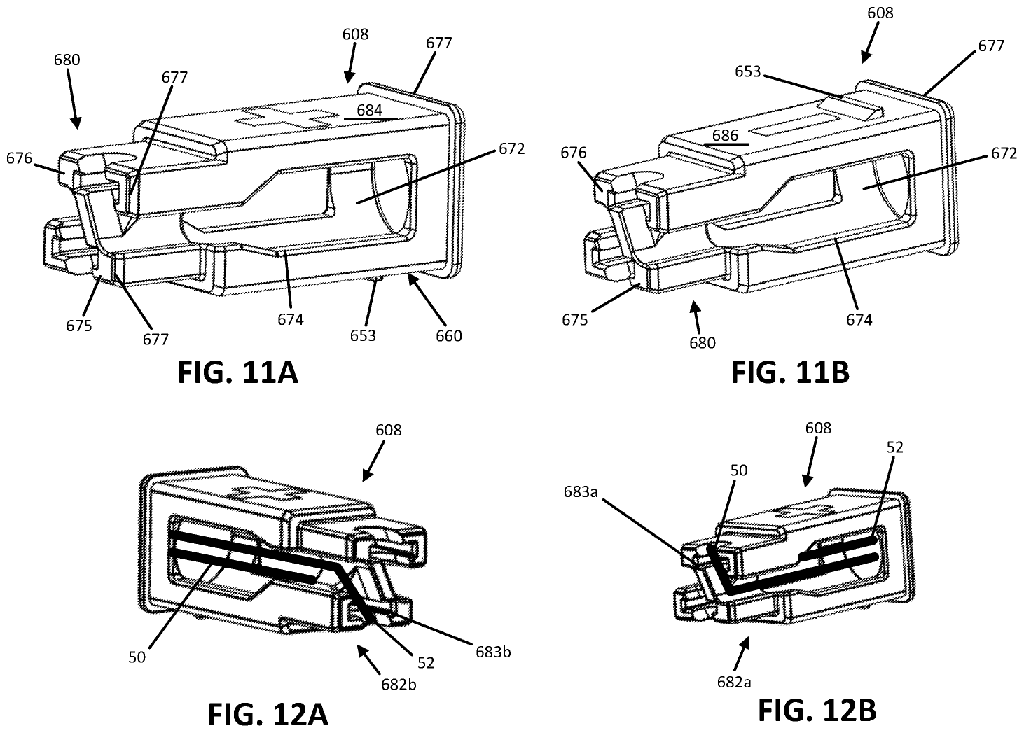

The rear connector body 608 of the free connector 600 generally corresponds to the rear connector body 208 of the free connector 200. However, modifications made to the rear connector body 208, now evident in rear connector body 602, can be appreciated with respect to FIGS. 11A-11B and 12A-12B.

As shown, the rear connector body 608 of the free connector 600 includes a rear body portion 660 that defines a central cavity 672 into which is inserted a pair of conductors. Each side face is provided with an elongate opening 674, which extends through a front face 675 of the rear connector body 608, into which the inward directed beams 652 (see FIG. 6) of the metal frame 604 extend wherein an electrical interface with the foil (or drain wire) of a conductor within the cavity 672 is established. The elongate opening 674, being extended through the front face 675, provides an open access to any conductor inserted within the cavity 672, A latch 653 on a lower face 686 of the rear body portion 660 interfaces with a cut-out 673 (see FIG. 911) of the metal frame 604 to secure the rear connector body 608 to the metal frame 604. A lip edge 677 of the rear body portion 660 seats against a rear face 657 of the metal frame 604. The front face 675 of the rear connector body 608 presents a flat front surface 676, to seat flush against the forward connector body 602, and beveled edges 677 to ease sliding the rear connector body 608 relative to the forward connector body 602.

The rear connector body 608 of the free connector 600 includes a contact receiving portion 680 that extends forward from the rear body portion 660. The contact receiving portion 680 is essentially divided into a first half 682a to accommodate the upper positioned electrical contact 606a and a second half 682b to accommodate the lower positioned electrical contact 606b. The first half 682a of the contact receiving portion 680 includes an upward channel that is contoured to direct the end of a conductor upward (e.g., a 90 deg. bend) to extend across a contact receiving slot 683a, see FIG. 12B with conductor 50. The second half 682b of the contact receiving portion 680 includes a downward channel that is contoured to direct the end of a conductor downward (e.g., a 90 deg. bend) to extend through a contact receiving slot 683b, see FIG. 12A, with conductor 52. In certain embodiments, an upper face 684 of the rear connector body 608 is marked with a plus sign, e.g., “+”, to indicate a positive terminal relative to the upward channel while a lower face 686 of the rear connector body 608 is marked with a minus sign, e.g., “−”, to indicate a negative terminal relative to the downward channel.

It will be appreciated that aspects of the above embodiments may be combined in any way to provide numerous additional embodiments. These embodiments will not be described individually for the sake of brevity.

While the present invention has been described above primarily with reference to the accompanying drawings, it will be appreciated that the invention is not limited to the illustrated embodiments; rather, these embodiments are intended to disclose the invention to those skilled in this art. Note that features of one or more embodiments can be incorporated in other embodiments without departing from the spirit of the invention. In the drawings, like numbers refer to like elements throughout. Thicknesses and dimensions of some components may be exaggerated for clarity.

It will be understood that, although the terms first, second, etc. may be used herein to describe various elements, these elements should not be limited by these terms. These terms are only used to distinguish one element from another. For example; a first element could be termed a second element, and, similarly, a second element could be termed a first element, without departing from the scope of the present invention.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of One or more other features, operations, elements, components, and/or groups thereof.

Herein, the terms “attached”, “connected”, “interconnected”, “contacting”, “mounted” and the like can mean either direct or indirect attachment or contact between elements, unless stated otherwise.

Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A connector comprising:
a forward connector body, including a forward portion and a rearward portion;
a rear connector body that interfaces with the forward connector body, the rear connector body defining a central channel to receive a single pair of conductors, each of a first and second side faces of the rear connector body including an elongate opening extending through a front face of the rear connector body providing access to an upward channel and a downward channel, respectively, of a contact receiving portion of the rear connector body; and
a metal frame positioned having a rearward portion and forward portion, the rearward portion of the metal frame positioned about the rear connector body and a rearward portion of the forward connector body, the forward portion of the metal frame positioned about the forward portion of the forward connector body.

2. The connector of claim 1, wherein the front face of the rear connector body presents a flat surface.

3. The connector of claim 2, wherein the edges of the front face of the rear connector body are beveled.

4. The connector of claim 1, wherein the metal frame is a unitary component.

5. The connector of claim 1, wherein the forward portion of the metal frame includes first and second cantilevered side arms.

6. The connector of claim 5, wherein each of the first and second cantilevered sider arms includes a cut-out that interfaces with a corresponding projection located on the forward portion of the forward connector body.

7. The connector of claim 5, wherein the first cantilevered side arm is positioned about an upper face, a first side face and a lower face of the forward portion of the forward connector body.

8. The connector of claim 5, wherein the second cantilevered side arm includes a recessed portion that is conformed to a keying notch in a second side face of the forward connector body, the second cantilevered arm positioned about the second side face and the lower face of the forward portion of the forward connector body.

9. The connector of claim 1, wherein the metal frame includes a plurality of forward-facing edges and wherein at least a portion of the plurality of forward-facing edges are beveled.

10.-20. (canceled)

21. The connector of claim 1, wherein the forward connector body includes a cantilevered latch supported by a t-mount.

22. The connector of claim 1, further comprising exactly two contacts, each having first ends that comprise a tuning fork contact and each have second ends that comprise insulation displacement contacts (IDCs).

23. The connector of claim 22, wherein the single pair of conductors, comprising a first conductor and a second conductor, are electrically coupled to first and second contacts of the exactly two contacts with the electrically coupled conductors and contacts transmitting both power and data.

24. A method of assembling a connector that includes a metal frame having a forward portion and a rearward portion, a rearward connector body, and a forward connector body interfacing with the rearward connector body, the method comprising:
positioning the rearward portion of the metal frame about both the rearward connector body and a portion of the forward connector body;
flexing the first cantilevered arm to place the first cantilevered arm in contact with the forward connector body including contact with an upper face, a first side face and a lower face of the forward connector body and securing the first cantilevered arm in position; and
flexing the second cantilevered to place the second cantilevered arm in contact with the forward connector body including with contact with a second side face and the lower face of the forward connector body and securing the second cantilevered arm in position.

25. The method of claim 24, wherein positioning the rearward portion of the metal frame additionally includes positioning a portion of the metal frame beneath a cantilevered latch of the connector and immediately proximate a t-shaped mount of the cantilevered latch.

26. The method of claim 24, wherein the second cantilevered arm is additionally placed in contact with a keying notch of the forward connector body.

27. The method of claim 26, wherein the second cantilevered arm is conformed to a shape of the keying notch.

28. The method of claim 24, wherein the contact of the first cantilevered arm with the upper face of the forward connector body extends from the first side face of the forward connector body to the second side face of the forward connector body.

29. The method of claim 24, further comprising beveling at least a portion of forward facing edges of the metal frame.

30. The method of claim 24, further comprising housing exactly two power- and data-transmitting contacts within the forward connector body.
